(19) United States
(12) Patent Application Publication
(10) Pub. No.: US 2024/0317616 A1
(43) Pub. Date: Sep. 26, 2024

(54) PFAS DESTRUCTION USING PLASMA AT THE AIR-WATER INTERFACE CREATED BY SMALL GAS BUBBLES

(71) Applicant: EVOQUA WATER TECHNOLOGIES LLC, Pittsburgh, PA (US)

(72) Inventors: Simon Paul Dukes, Chelmsford, MA (US); Joshua W. Griffis, Asburnham, MA (US); Yang Chen, Lowell, MA (US); George Y. Gu, Austin, TX (US)

(21) Appl. No.: 18/689,667

(22) PCT Filed: Aug. 30, 2022
(86) PCT No.: PCT/US2022/042002

§ 371 Date: Mar. 6, 2024

Related U.S. Application Data
(60) Provisional application No. 63/238,243, filed on Aug. 30, 2021.

(51) Int. Cl. C02F 1/48; C02F 1/24

(52) U.S. Cl. CPC C02F 1/48; C02F 1/24; C02F 2303/26; C02F 2305/023

(57) ABSTRACT

Systems and methods for treating water containing PFAS are disclosed. Plasma activated excited gas is encapsulated with nanobubbles in water comprising PFAS to be treated. Liquid-phase reaction of the PFAS with the encapsulated plasma activated excited gas at the air-water interface of the nanobubbles is promoted. The PFAS can be concentrated upstream of the plasma reactor. A foam fractionation process may be used in conjunction with the plasma reactor to facilitate PFAS removal.

### CROSS-REFERENCE TO RELATED APPLICATION

This application claims priority under 35 U.S.C. § 119(e) to U.S. Provisional Patent Application Ser. No. 63/238,243, titled “PFAS DESTRUCTION USING PLASMA AT THE AIR-WATER INTERFACE CREATED BY SMALL GAS BUBBLES” and filed on Aug. 30, 2021, the entire disclosure of which is hereby incorporated herein by reference in its entirety for all purposes.

### FIELD OF TECHNOLOGY

Aspects and embodiments disclosed herein relate generally to the treatment of water containing per- and polyfluoroalkyl substances (PFAS).

### BACKGROUND

There is rising concern about the presence of various contaminants in municipal wastewater, surface water, drinking water, and groundwater. For example, perchlorate ions in water are of concern, as well as PFAS, PFAS degradation products and PFAS precursors, along with a general concern with respect to total organic carbon (TOC).

PFAS are man-made chemicals used in numerous industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

It appears that even low levels of bioaccumulation may lead to serious health consequences for contaminated subjects such as human beings, the young being especially susceptible. The environmental effects of these compounds on plants and microbes are as yet largely unknown. Nevertheless, serious efforts to limit the environmental release of PFAS have commenced and continue to emerge.

### SUMMARY

In accordance with one or more aspects, a system for treating water containing per- and polyfluoroalkyl substances (PFAS) is disclosed. The system may include a plasma reactor fluidly connected to both a source of water comprising PFAS and to a source of a carrier gas, the plasma reactor configured to produce plasma activated excited gas. The system may further include a nanobubble generator constructed and arranged to form nanobubbles encapsulating the plasma activated excited gas in the water comprising PFAS. The plasma reactor may be configured to promote liquid-phase reaction of the PFAS with the encapsulated plasma activated excited gas at the air-water interface of the nanobubbles.

In some aspects, the PFAS may include perfluorooctane sulfonic acid (PFOS) and/or perfluorooctanoic acid (PFOA). The plasma reactor may promote generation of OH, O and/or H radicals.

In some aspects, the nanobubbles may have a mean diameter of less than about 1 μm. In some non-limiting aspects, the nanobubbles may have a mean diameter ranging from about 75 nm to about 200 nm. In at least some aspects, a concentration of nanobubbles in the water comprising PFAS may be in the range of about 1×10⁶ to about 1×10⁸ nanobubbles per mL. In some aspects, the nanobubbles exhibit neutral buoyancy. In some aspects, the nanobubble generator may be positioned within the plasma reactor.

In some aspects, the plasma reactor may include a controllable power supply. In some non-limiting aspects, the system may further include a concentrating unit operation fluidly connected to the source of water comprising PFAS upstream of the plasma reactor. In some aspects, the system may further include a foam fractionation unit operation fluidly connected upstream or downstream of the plasma reactor.

In some aspects, the system may be configured to remove at least about 95% of PFAS from the water.

In accordance with one or more aspects, a method of treating water comprising per- and polyfluoroalkyl substances (PFAS) is disclosed. The method may include steps of forming plasma activated excited gas, encapsulating the plasma activated excited gas with nanobubbles in water comprising PFAS to be treated, and promoting liquid-phase reaction of the PFAS with the encapsulated plasma activated excited gas at the air-water interface of the nanobubbles.

In some aspects, the PFAS may include perfluorooctane sulfonic acid (PFOS) or perfluorooctanoic acid (PFOA). In at least some aspects, the plasma activated excited gas may include OH, O and/or H radicals.

In some aspects, the nanobubbles may have a mean diameter ranging from about 75 nm to about 200 nm.

In some aspects, the method may further include a step of adjusting an electrical voltage associated with forming the plasma activated excited gas in response to at least one measured parameter of the water comprising PFAS to be treated. In at least some aspects, the method may further include a step of adjusting a concentration or a size of the nanobubbles.

In some aspects, the method may further include concentrating PFAS in the water to be treated. In some non-limiting aspects, the method may further include adjusting a temperature, a flow rate and/or a flow direction of the water comprising PFAS to be treated.

In at least some aspects, the plasma activated excited gas may be formed concurrently with the nanobubbles.

In some aspects, the method may further include delivering a product stream containing unreacted PFAS to a foam fractionation process. PFAS in a fractionated stream may be mineralized.

In some aspects, the method may be associated with a PFAS removal rate of at least about 95%.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 presents a schematic of a PFAS removal mechanism in accordance with one or more embodiments; and

FIG. 2 illustrates a system for treating water containing PFAS in accordance with one or more embodiments.

### DETAILED DESCRIPTION

In accordance with one or more embodiments, systems and methods may treat a contaminated source of water to safe levels by removing PFAS or other refractory contaminants.

PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties.

Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, PFAS compounds are readily released into the environment where their extreme hydrophobicity as well as negligible rates of natural decomposition results in environmental persistence and bioaccumulation.

In general, it may be desirable to have flexibility in terms of selecting an approach for water treatment. For example, the source and/or constituents of the process water to be treated may be a relevant factor. Various federal, state and/or municipal regulations may also be important factors. The U.S. Environmental Protection Agency (EPA) developed revised guidelines in May 2016 of a combined lifetime exposure of 70 parts per trillion (PPT) for PFOS and PFOA. Federal, state, and/or private bodies may also issue relevant regulations. Market conditions may also be a controlling factor. These factors may be variable and therefore a preferred water treatment approach may change over time.

In accordance with one or more embodiments, systems and methods for treating water containing PFAS are provided. The water may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background TOC is 50 ppm, a conventional PFAS removal treatment, such as an activated carbon column, may exhaust very quickly. Thus, it may be desirable to remove TOC prior to treatment for PFAS removal. For example, target organic alkanes, alcohols, ketones, aldehydes, acids, or others in the water may be oxidized. In some embodiments, the water containing PFAS may further contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC. In accordance with one or more embodiments, systems and methods for treating water containing PFAS involving the use of plasma to mineralize PFAS compounds are disclosed. Plasma water treatment is an advanced oxidation process (AOP) and advanced reduction process (ARP) which can also provide disinfection and bio-decontamination. The PFAS oxidation threshold is generally considered to be greater than about 2.8 eV.

Plasma can generally dissociate a gas molecule to form active species. For example, when carbon fluoride gas is discharged into a plasma, it can be used to etch various material such as glass, metal or plastic. The carbon fluoride gas itself is not reactive or with a negligible reactivity to the various materials but the plasma gas exhibits enhanced reactivity. The discharged gas (plasma) is believed to form a radical or various active (excited molecular state) species. O₂ plasma forms O radicals and other molecular oxygen activated (excited states) species. H₂ plasma forms H radical and other hydrogen molecular activated (excited) species. O₂ and H₂ mixture plasma forms H, O and OH among other radical and other excited molecular species. H₂O plasma forms OH radical and other excited molecular species. Mixing H₂ plasma with non-discharged O₂ plasma may form O and OH radicals. Plasma generated active species are too many to be listed here but are generally known to those of skill in the relevant art. Plasma activated gas species can also transport its energy to a second gas acceptor to form different active species.

In accordance with one or more embodiments, an efficient way to destroy or mineralize PFAS involves introducing OH, O, H and/or other radicals. These radicals can react with PFAS to form CO₂ and fluoride ions. The radical usually has a longer half-life when in the gaseous phase than in the water solution. This is because in the gaseous phase there is a much lower collision rate than that in the water phase. The reaction of the active species with the PFAS that will result in a dissociation of the molecule involves an interaction between the radical and the hydrophobic CF chain of the PFAS molecule. When the radical in the water solution interacts with the PFAS molecule, only the effective collision will result in the destruction of the PFAS molecule. A non-effective collision will lead to the radical being deactivated and this require additional activated species.

In accordance with one or more embodiments, plasma gas is produced and introduced into the water phase to form bubbles, preferably very small bubbles also known as nanobubbles as described further below: The plasma activated (excited) gas species will stay inside the gas bubbles and meanwhile the PFAS, due to its amphiphilic nature, will have its CF chain stick onto the air-water interface of the bubble. This makes the plasma CF chain reaction more efficient with the effective collision provided by such PFAS molecule orientation.

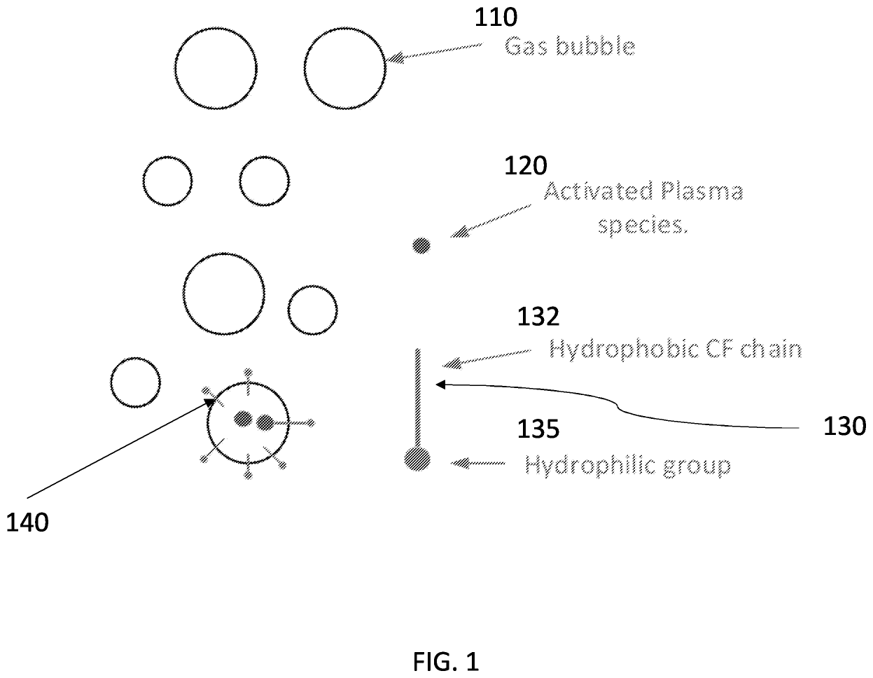

FIG. 1 presents a schematic of the PFAS removal mechanism involved in the various embodiments disclosed herein. A plurality of nanobubbles 110 encapsulates activated plasma species 120. PFAS 130 includes hydrophobic CF chain 132 and hydrophilic group 135. The amphiphilic PFAS molecule 130 gathers at the air-water interface 140 and is subject to an oxidation reaction between the activated gas species 120 and the CF chain 132.

Systems described herein may generally include a plasma generator that has an inlet fluidly connected to a source of water containing PFAS. The plasma generator is also fluidly connected to a source of a carrier gas for production of the activated gas species (radicals). The carrier gas may be air or any other gas generally selected based on the types of resultant radicals desired. The carrier gas is injected through an electrode set connected to an arc generator which ignites plasma. The reactor may generally be configured to deliver aqueous electrons that are excited, for example, to about 50 to about 100 eV. In at least some embodiments, the plasma reactor promotes generation of OH, O and/or H radicals.

The plasma gas is introduced to water containing PFAS within the plasma reactor to form bubbles encapsulating the plasma gas. The plasma gas reacts with CF chains of PFAS at the air-water interface of the bubbles as described above for PFAS destruction.

The plasma generator may generally be constructed and arranged to promote a high radical density, increase residence time of water, and increase plasma exposure. With electrification as the primary input, energy efficiency is also a key design parameter and it may be desirable to minimize associated electrical energy per order (EEO) (kWh/m³). Various plasma generation techniques will be discernible to those of ordinary skill in the art. In some non-limiting embodiments, an implemented plasma generator may be a Plasma Vortex™ or other water treatment system commercially available from Onvector LLC (Somerville, MA).

In some embodiments, the plasma reactor may include a controllable power supply. Thus, excitation level of the activated plasma gas may be tunable based on one or more operational parameters. For example, applied voltage may be adjusted based on a concentration of one or more constituents such as PFAS in the source of water to be treated.

In accordance with one or more embodiments, the plasma activated excited gas is encapsulated with bubbles in the water containing PFAS. In some embodiments, the bubbles are nanobubbles having a mean diameter of less than about 1 μm. In at least some preferred embodiments, the nanobubbles have a mean diameter ranging from about 75 nm to about 200 nm. The nanobubbles may have an average diameter of about 100 nm and range in diameter between about 70 and about 120 nm. In some embodiments, a concentration of nanobubbles in the water comprising PFAS is in the range of about 1×10⁶ to about 1×10⁸ nanobubbles per mL.

Beneficially, the nanobubbles may generally exhibit neutral buoyancy to promote plasma interaction and to maximize surface area in contact with the water to be treated. Their negative surface charge may prevent them from coalescing. The nanobubbles may also be electrochemically active, produce oxidants and/or reduce surface tension. The nanobubbles are stable in liquid because they have reached equilibrium in terms of surface tension, internal and external pressure, surface charge and their environment. The nanobubbles may generally remain stable in liquid until they interact with surfaces or contaminants

In accordance with one or more embodiments, a nanobubble generator may cooperate with the plasma generator to form nanobubbles encapsulating the plasma activated excited gas. The nanobubble generator may be constructed and arranged to form nanobubbles encapsulating the plasma activated excited gas in the water comprising PFAS. Various techniques of forming nanobubbles will be readily apparent to those of skill in the relevant art. In at least some embodiments, the nanobubble generator may be one commercially available from Moleaer Inc. (Carson, CA). In some non-limiting embodiments, the nanobubble generator may be positioned within the plasma reactor. In other embodiments, the nanobubble generator may be external to the plasma reactor. In at least some embodiments, the nanobubble generator may be along a carrier gas feed associated with the plasma generator.

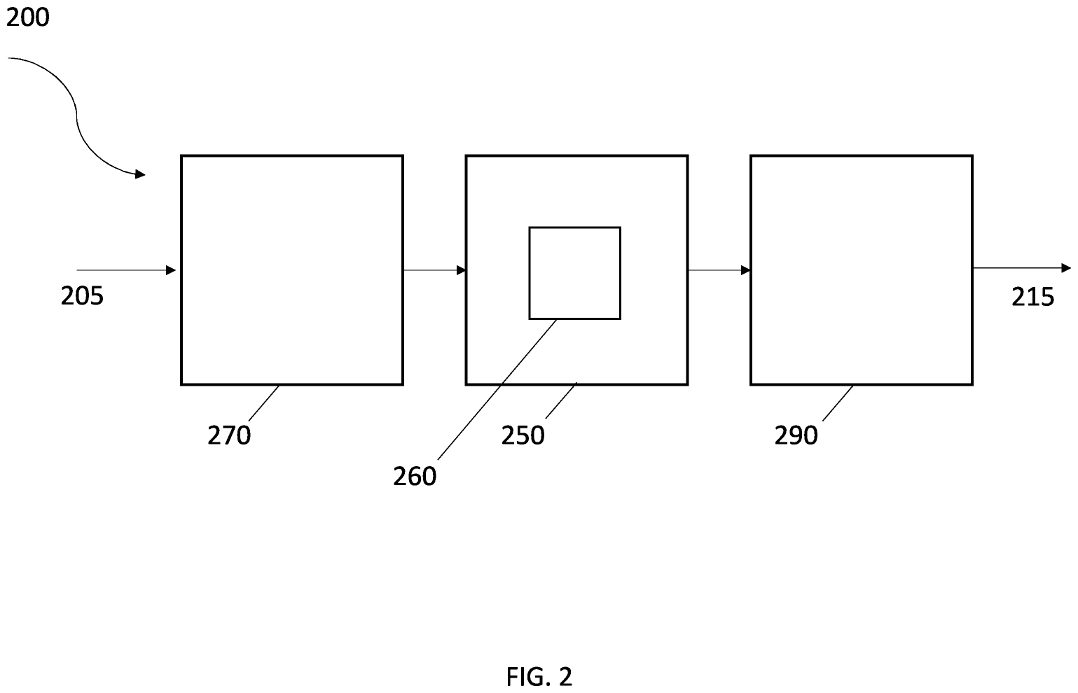

Embodiments of a water treatment system for PFAS removal and destruction involving plasma treatment are illustrated in FIG. 2. System 200 includes a source of water 205 containing PFAS to be treated. Water source 205 is fluidly connected to plasma reactor 250. The plasma reactor 250 is configured to produce plasma activated excited gas.

A concentrating unit operation 270 may be positioned upstream of plasma reactor 250. The concentrating unit operation 270) may be any suitable separation system that can produce a stream enriched in PFAS or other compounds. For example, concentrating unit operation 270) can be a reverse osmosis (RO) system, a nanofiltration (NF) system, an ultrafiltration system (UF), or electrochemical separations methods, e.g., electrodialysis, electrodeionization, etc. The concentrating unit operation 270) may also involve a dissolved air flotation (DAF) or foam fractionation process and may be staged. In such implementations, the reject, retentate or concentrate streams from these types of separation systems will include water enriched in PFAS. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. The concentrated stream may be delivered to the plasma reactor 250. In some embodiments of the system, the source of water 205 containing PFAS can be directed to the plasma reactor 250 without the need for upstream concentration to produce a stream of water enriched in PFAS.

System 200 may further include a nanobubble generator 260. The nanobubble generator 260 may generally be associated with the plasma reactor 250 to form nanobubbles encapsulating the plasma activated excited gas in the water comprising PFAS. Plasma activated excited gas produced by the plasma reactor 250 may be input to the nanobubble generator 260. Nanobubble generator 260 is presented as being positioned within nanobubble generator 260) but other configurations are within the scope of the present disclosure. In at least some embodiments, the plasma activated excited gas may be formed concurrently with the nanobubbles.

The plasma reactor 250) is configured to promote liquid-phase reaction of the PFAS with the encapsulated plasma activated excited gas at the air-water interface of the nanobubbles. The mechanism of FIG. 1 may generally take place within plasma reactor 250 to effect PFAS destruction.

In accordance with one or more embodiments, system 200 may include a further treatment unit operation 290 fluidly connected downstream of plasma generator 250. In at least some embodiments, a foam fractionation unit operation 290 may be fluidly connected downstream of the plasma reactor 250.

Beneficially, the nanobubbles formed by the nanobubble generator 260 may also be used to facilitate the foam fractionation process 290. Nanobubbles may generally enhance the performance of dissolved air flotation (DAF) systems. In addition to improving biological and chemical oxidation processes, nanobubbles also enhance physical separation. Their neutral buoyancy, hydrophobic nature, and negative surface charge may generally attract them to water contaminants including fats, oils, grease, surfactants, colloids, and solids. As more and more nanobubbles surround the contaminant, the entrained contaminant separates from solution enabling it to be easily removed by flotation or filtration. Thus, unreacted PFAS may overflow at the top of vessel 290 forming foam that can be skimmed away. PFAS in any fractionated stream may then be mineralized. Various foam fractionation and/or DAF techniques for implementation in conjunction with the plasma treatment disclosed herein will be readily apparent to those of skill in the art.

In some embodiments, other supplemental techniques for PFAS removal, such as the use of ion exchange resin and/or activated carbon treatment can be used in conjunction with the approaches described herein.

The treated water 215 produced by the system 200 may be substantially free of the PFAS. The treated water 215 being “substantially free” of the PFAS may have at least 90% less PFAS by volume than the waste stream. The treated water 215 being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water 205. The systems and methods disclosed herein may remove at least 92%, at least 95%, at least 98%, at least 99%, at least 99.9%, or at least 99.99% of PFAS by volume from the source of water 205. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In accordance with one or more embodiments, a method for water treatment may include forming plasma activated excited gas, encapsulating the plasma activated excited gas with nanobubbles in water comprising PFAS to be treated, and promoting liquid-phase reaction of the PFAS with the encapsulated plasma activated excited gas at the air-water interface of the nanobubbles.

In some non-limiting embodiments, the plasma activated excited gas may comprise OH, O and/or H radicals. In some non-limiting embodiments, the nanobubbles may have a mean diameter ranging from about 75 nm to about 200 nm. In some non-limiting embodiments, PFAS in the water to be treated may be concentrated prior to plasma treatment. In some non-limiting embodiments, a product stream containing unreacted PFAS may be delivered to a foam fractionation process.

In accordance with one or more embodiments, disclosed systems and methods may include a control scheme to facilitate PFAS destruction. An electrical voltage associated with forming the plasma activated excited gas may be adjusted in response to at least one measured parameter of the water comprising PFAS to be treated, e.g. PFAS concentration. Likewise, a concentration or a size of the nanobubbles generated may be adjusted in response to one or more process parameters. One or more characteristics of the water containing PFAS to be treated may be adjusted to facilitate PFAS removal such as its temperature, pressure, flow rate and/or flow direction either within or external to the plasma reactor.

In some embodiments, systems and methods disclosed herein can be designed for centralized applications, onsite application, of mobile applications via transportation to a site. The centralized configuration can be employed at a permanent processing plant such as in a permanently installed water treatment facility such as a municipal water treatment system. The onsite and mobile systems can be used in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container.

### Prophetic Example

The function and advantages of these and other embodiments can be better understood from the following example. This example is intended to be illustrative in nature and not considered to be in any way limiting the scope of the invention.

PFAS Removal Via Plasma Treatment with Nanobubbles

In this prophetic example, the ability of plasma treatment to destroy PFAS will be explored. A source of water containing PFAS will be supplied to a plasma reactor in association with a nanobubble generator as described herein. The system will be operated for about one hour. The concentration (ng/L) of various PFAS compounds (including both PFOA and PFOS) will beneficially be shown to decrease over time. At least 99% destruction of total measurable PFAS will be demonstrated. The opportunity for reduction of associated EEO, as well as reduced formation of short chain products, will present itself for future work. Unreacted PFAS may be delivered to a downstream foam fractionation process to facilitate further PFAS separation and mineralization.

The phraseology and terminology used herein is for the purpose of description and should not be regarded as limiting. As used herein, the term “plurality” refers to two or more items or components. The terms “comprising.” “including,” “carrying.” “having.” “containing,” and “involving.” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A system for treating water comprising per- and polyfluoroalkyl substances (PFAS), comprising:
a plasma reactor fluidly connected to both a source of water comprising PFAS and to a source of a carrier gas, the plasma reactor configured to produce plasma activated excited gas; and
a nanobubble generator constructed and arranged to form nanobubbles encapsulating the plasma activated excited gas in the water comprising PFAS,
the plasma reactor configured to promote liquid-phase reaction of the PFAS with the encapsulated plasma activated excited gas at the air-water interface of the nanobubbles.

2. The method of claim 1, wherein the PFAS comprise perfluorooctane sulfonic acid (PFOS) and/or perfluorooctanoic acid (PFOA).

3. The system of claim 1, wherein the plasma reactor promotes generation of OH, O and/or H radicals.

4. The system of claim 1, wherein the nanobubbles have a mean diameter of less than about 1 μm.

5. The system of claim 4, wherein the nanobubbles have a mean diameter ranging from about 75 nm to about 200 nm.

6. The system of claim 1, wherein a concentration of nanobubbles in the water comprising PFAS is in the range of about 1×10⁶ to about 1×10⁸ nanobubbles per mL.

7. The system of claim 1, wherein the nanobubbles exhibit neutral buoyancy.

8. The system of claim 1, wherein the plasma reactor comprises a controllable power supply.

9. The system of claim 1, further comprising a concentrating unit operation fluidly connected to the source of water comprising PFAS upstream of the plasma reactor.

10. The system of claim 1, wherein the nanobubble generator is positioned within the plasma reactor.

11. The system of claim 1, further comprising a foam fractionation unit operation fluidly connected upstream or downstream of the plasma reactor.

12. The system of claim 1, configured to remove at least about 95% of PFAS from the water.

13. A method of treating water comprising per- and polyfluoroalkyl substances (PFAS), comprising:
forming plasma activated excited gas;
encapsulating the plasma activated excited gas with nanobubbles in water comprising PFAS to be treated; and
promoting liquid-phase reaction of the PFAS with the encapsulated plasma activated excited gas at the air-water interface of the nanobubbles.

14. The method of claim 13, wherein the PFAS comprise perfluorooctane sulfonic acid (PFOS) and/or perfluorooctanoic acid (PFOA).

15. The method of claim 13, wherein the plasma activated excited gas comprises OH, O and/or H radicals.

16. The system of claim 13, wherein the nanobubbles have a mean diameter ranging from about 75 nm to about 200 nm.

17. The method of claim 13, further comprising adjusting an electrical voltage associated with forming the plasma activated excited gas in response to at least one measured parameter of the water comprising PFAS to be treated.

18. The method of claim 13, further comprising adjusting a concentration or a size of the nanobubbles.

19. The method of claim 13, further comprising concentrating PFAS in the water to be treated.

20. The method of claim 13, further comprising adjusting a temperature, a flow rate and/or a flow direction of the water comprising PFAS to be treated.

21. The method of claim 13, wherein the plasma activated excited gas is formed concurrently with the nanobubbles.

22. The method of claim 13, further comprising delivering a product stream containing unreacted PFAS to a foam fractionation process.

23. The method of claim 22, further comprising mineralizing PFAS in a fractionated stream.

24. The method of claim 13, associated with a PFAS removal rate of at least about 95%.
